(19) United States
(12) Patent Application Publication
(10) Pub. No.: US 2023/0133699 A1
(43) Pub. Date: May 4, 2023

(54) Work Machine Having a Hood to Cover or Open an Opening

(71) Applicant: Wacker Neuson Produktion GmbH & Co. KG, Reichertshofen (DE)

(72) Inventors: Robert Hartmann, Munchen (DE); Ferdinand Rupp, Obergunzburg (DE); Andreas Bartl, Worth (DE)

(21) Appl. No.: 17/975,855

(22) Filed: Oct. 28, 2022

(30) Foreign Application Priority Data
Oct. 29, 2021 (DE) 10 2021 128 299

(51) Int. Cl. E02F 9/08; E02F 9/16

(52) U.S. Cl. CPC E02F 9/0891; E02F 9/163

(57) ABSTRACT

A mobile work machine has a loadbearing frame and a drive unit. A covering unit can be moved for into and out of a covering position covering a loadbearing frame opening for covering the drive unit. At least one closure unit for selectively holding the covering unit in a closure position has at least one first closure element and one second closure element which can be adjusted along an adjustment path relative to the first closure element. The closure unit has at least one obstacle to be overcome during the relative adjustment of the first and second closure element. The obstacle defines a release path during opening which is oriented in the direction of the adjustment path and, defines a fixing path during closing which is oriented in the direction of the adjustment path. The release path for the opening is greater than the fixing path.

### BACKGROUND OF THE INVENTION

### 1. Field of the Invention

The invention relates to a mobile work machine with a loadbearing frame and with a drive unit for driving at least one drive element and/or one work element. More particularly, the work machine has at least one hood or “covering unit” which can be adjusted about a pivot axis being provided for covering/closing or opening an opening, in particular a loadbearing frame opening of the loadbearing frame for covering the drive unit.

### 2. Description of the Related Art

Mobile work machines, in particular wheel loaders, telescopic handlers, excavators, tractors or the like, with a vehicle frame and with a drive unit for driving at least one drive element such as a running wheel or track are usually operated nowadays by way of a refillable fuel. Here, mainly diesel-powered vehicles are used today. In the meantime, electrically driven machines are also already in use. Apart from in the case of, for example, wheel loaders with large scoops on the lift arm, modern, mobile work machines frequently have releasably connectable work tools, for example which can be held and released via what are known as “quick-change units” or “exchangeable plates”.

Moreover, soil compaction apparatuses such as vibratory rammers, vibratory plates or rollers, etc. are already well known as work machines and have been in use on various components for decades, for example EP 1 097 272. For instance, rammers or vibratory plates, above all, comprise an upper mass with a motor, that is to say, generally an internal combustion engine or electric motor, and a lower mass which can be moved relative thereto with the padfoot or bottom plate. The relative movement between the upper mass and the lower mass is usually damped by way of spring assemblies.

Rammers or vibratory plates are accordingly construction/work units which can be used in a mobile manner, and which usually input energy into the soil and shift and compress the soil as a result via centrifugal force exciters on the lower mass. The drive of the centrifugal force exciters takes place by way of gasoline engines, diesel engines or electric motors which are as a rule arranged on the upper mass which is coupled elastically with respect to the lower mass.

Mobile work machines of this type are greatly loaded during operation under the rough and dirty construction site conditions and, above all, the high mechanical loads and vibrations. Particular requirements have to be met precisely for components such as the covers of various openings and the hinges and closures, in order to be durable in the long term. In addition, they should be comparatively inexpensive.

Thus, for example, hood tighteners of comparatively simple construction and drawbars made from rubber are firstly used, and relatively complicated and expensive, metallic turnbuckles or even door locks of complex construction which can be closed by way of keys and have a spiral spring mechanism, etc. are secondly used.

It is disadvantageous here, however, that they are in part very expensive or unpleasant to open, or that they spontaneously open in the case of pronounced vibrations or are subject to wear and break relatively rapidly.

### SUMMARY OF THE INVENTION

In contrast, it is an object of the invention to propose a mobile work machine which improves the disadvantages of the prior art at least partially, in particular which can be implemented in an economically favorable manner and/or which can be opened by hand comfortably by the operator, and/or in which undesired opening or release is prevented effectively.

Proceeding from a mobile work machine of the type mentioned in the introduction, this object is achieved by providing mobile work machine comprising a loadbearing frame, a drive unit for driving a driven device including at least one drive element and/or at least one work element, at least one covering unit which can be moved about a pivot axis from a closure position that covers an opening in the loadbearing frame to cover the drive unit to an open position exposing the opening to render the drive unit accessible through the opening, and at least one closure unit that is configured to hold the covering unit in the closure position. The closure unit has at least one first closure element and one second closure element which can be adjusted along an adjustment path relative to the first closure element. The closure unit also has at least one obstacle that must be overcome during the relative adjustment of the first and second closure elements, with the result that, during an opening movement of the covering unit, the obstacle defines a release path which is oriented in the direction of the adjustment path and that, during a closing movement of the closure unit, defines a fixing path which is oriented in the direction of the adjustment path. The release path is greater than the fixing path.

Accordingly, a mobile work machine according to the invention is distinguished by the fact that the release path for the opening is greater than the fixing path for the fixing.

With the aid of this measure, it is achieved that the opening can be closed or covered by the operator with little force, and that the covering (in particular, hood or door) does not come undone or open during operation even in the case of great shocks or vibrations. The energy requirement for opening is thus comparatively great, which leads to coming undone or opening being prevented effectively during operation, but opening by hand being realizable with a comparatively low force over the relatively long release path. This means that, although the operator requires a relatively long path and therefore a somewhat longer time for opening, the manual forces or opening forces comparatively low. Nevertheless, spontaneous opening or coming undone is prevented, since, although a shock or vibration which is oriented in the direction of opening can certainly have a relatively great force in rough work/construction operation, it acts in the direction of opening only for a very short time and/or does not apply the energy necessary for opening, in order to overcome the obstacle.

This is a departure from previous principles which have been practiced for decades in the case of closure units for coverings of openings in the case of construction/work machines with relatively pronounced shocks or vibrations during operation.

The fixing path and the release path are preferably defined within the context of the invention in such a way that the fixing path for the fixing extends from an initial contact position as far as the closure position, the initial contact position being configured as first contact position in the direction of the adjustment path during the fixing, and/or that the release path for the opening extends from the closure position as opening starting contact position as far as an end contact position, the end contact position being configured as last release contact position in the direction of the adjustment path during the opening. This means that these two paths according to the invention extends substantially firstly from/as far as what is known as the “normal” closure position or rest position and secondly as far as/from in each case one position, in which the first and the second closure element still just touch one another or are in contact. These two positions (that is to say, the “last” or “first” contact or touching position of the two closure elements) are not identical as in the prior art, but rather are different according to the invention in such a way that the release path for the opening is greater than the fixing path for the fixing.

The first closure element advantageously comprises at least the obstacle, the obstacle being configured as a projecting portion of the first closure element. As a result, the obstacle to be overcome can be configured and shaped in an advantageous way, which is particularly inexpensive, for example. An advantageous prestress and/or breakaway force can optionally be generated by way of the projecting portion. The projecting portion can be configured as a lock and/or latch. This improves the holding/fixing of the covering unit on the opening or the frame or the like.

In one particular development of the invention, the obstacle and/or the projecting portion are/is oriented at least partially in the direction of the fixing path, and/or an undercut of the obstacle and/or projecting portion is provided, and/or an acute angle is provided between the fixing path and the longitudinal axis of the obstacle and/or projecting portion. Thus, for example, an advantageous locking action or prestressing force can be implemented for holding/prestressing the covering unit on the opening or the frame. Secondly, a defined or greater breakaway force and/or obstacle force can also be implemented without great structural or economic outlay. In accordance with this advantageous measure, this locking action or prestressing force or breakaway force or obstacle force acts at least partially in the closing or fixing direction or in the direction of the fixing. This force can accordingly be said or defined in an advantageous way by way of the undercut or the projecting portion. What is known as “firm closing” can also be implemented hereby, which is generally perceived as being of high quality by the operator or user.

Moreover, it is achieved precisely by way of the acute angle of the projecting portion or the undercut that the closing is easier in terms of force than the opening. This improves the fixing/holding of the covering unit on the opening of the frame.

The first closure element preferably has at least one elastically deformable barb. By way of this, the second closure element or the covering unit is interlocked with the first closure element of the frame. Unintended opening during operation or on account of shocks or vibrations is thus additionally prevented.

The first closure element is preferably configured as an elastically deformable elastomer element, for example made from rubber or elastic plastic or the like. The first closure element or elastically deformable elastomer element is preferably injection molded. In this way, particularly inexpensive production of the first closure element even with comparatively complex cross sections/shapes or geometries such as, for example, with a projecting portion, a barb or an undercut, etc., can be realized.

In one advantageous variant of the invention, a first cross section of the obstacle and/or projecting portion is of smaller configuration than a second cross section of a second portion of the first closure element. In this way, the prestressing force and/or the latching and/or the closing can be realized and is set by way of the advantageous dimensioning and/or shape of the first cross section of the obstacle and/or predicting portion separately from the second cross section of the second portion of the first closure element. A deformation of the second cross section of the second portion of the first closure element can thus be brought about precisely by way of the latching of the obstacle or the projecting portion/undercut, which leads to a greater deformation force or resistance force during opening on account of the greater, second cross section. This can also be said or dimensioned in an advantageous way by way of the second cross section or the shape of the second portion. The second portion is preferably oriented in the direction of the adjustment path.

The second closure element advantageously has a square cross section. Loadbearing frames or the like often have, for example, frame or tube elements with a square cross section, such that a dual use of these frame elements is made possible as a result. The second closure element preferably has a diamond-shaped cross section in the direction of the adjustment path, that is to say the cross section is advantageously square and/or the sides are oriented at an angle of 45° with respect to the adjustment path.

It is generally advantageous for one or more of all the sides of the second closure element to be arranged obliquely or at an angle with respect to the adjustment path. Advantageous “inserting” and/or “pulling out” can thus be realized with regard to the first closure element.

In one preferred development of the invention, at least two first closure elements are arranged on the covering unit. In this way, for example, homogeneous and/or symmetrical loading or action of force can be generated, which has a positive effect. The two first closure elements are optionally arranged on two side edges/edge regions of the covering unit which are arranged opposite one another.

The second closure element is preferably arranged between two first closure elements. The second closure element can thus be in contact on both sides with in each case one first closure element, and can additionally be loaded with force. This is firstly space-saving, and the symmetrical force loading is secondly ensured by way of this.

A single-piece closure element structural unit advantageously comprises at least two first closure elements. This makes a particularly space-saving and inexpensive overall design and production possible.

In one particular variant of the invention, the second closure element has a contour which is exposed or oriented toward the first closure element, this contour being unsymmetrical perpendicularly with respect to the adjustment path. Hereby, the two paths of different magnitude according to the invention, that is to say the release path and the fixing path, can be realized by way of this advantageous design and shape of the second closure element.

It can generally be achieved with the aid of the invention that the conflict of objectives consisting in the pleasant operation by way of manual force and at the same time the avoidance of undesired opening of the hoods is solved in an advantageous way. The user or operator can thus open the covering unit or hood in a more pleasant and more rapid manner Here, the invention can have, inter alia, the advantages and features listed in the following text, both individually and in a combined way in part or all of them combined with one another:
The invention permits a comparatively great relative movement of the covering unit or the hood or door with respect to components which are fixed on the machine, without opening. As a result, the breakaway forces can be kept low. The great path and the prestress prevent undesired opening of the hood here, however.
Substantially at least one elastic component which holds a hood in a closed position, that is to say locked, by way of a non-positive and/or positively locking connection on at least one part which is fixed to the machine.
During the closing operation enduring the opening operation of the covering unit or hood, the elastomer component has to be elastically deformed further starting from the locked position, with the result that increased forces are necessary during opening and closing of the covering unit or hood and the locked covering unit or hood is held in a closed position.
The elastomer component can be provided with one or more segments, lugs, projections, barbs or the like which have to be deformed to different extents in the closing and opening direction, as a result of which the closing and opening force can be configured independently of one another by way of the implementation of the geometry of the segments.
In one embodiment, simple bending of the segments can take place during closure. During opening, turning inside out can be necessary, that is to say, an increased force requirement during opening.
The fixed component can be configured as an individual component, and the cross section can be configured to be round or with a geometry which influences the holding, closing and opening force.
In one embodiment, two elastomer components are configured which lock on one, preferably on two fixed components. As a result, the covering unit or hood will be centered in an advantageous way during closure in the case of a symmetrical arrangement.
In one embodiment, the two elastomer components are arranged at or close to the opening end of the covering unit or hood, possibly with a main deformation direction perpendicularly with respect to the pivot/hinge axis, and center the covering unit or hood on two frame elements such as, for example, tubes of an existing protective frame. Thus, for example during initial assembly, identical gaps to precisely these protective frame tubes can result, and the covering unit or hood possibly only requires setting of the connection to the hinge, that is to say the covering unit or hood is centered automatically on the opening side and can be set simply.
The ratio of positively locking and non-positive connection of a fixing or locking device can be influenced, for example, via the addition of slip additive to the material of the elastomer components, in order to achieve an intended combination of holding, closing and opening force.
In the locked state, the covering unit or hood is advantageously mounted elastically at the open end, for example toward the protective frame, that is to say reduced vibration loading for the covering unit or hood.
The elastomer component can be connected directly to the covering unit or hood, for example screwed, riveted, adhesively bonded or preferably by way of a positively locking connection.
In the case of fastening by way of a positively locking connection, the elastomer component is preferably plugged onto a fixed holding part which is connected to the covering unit or hood. To this end, the holding part can be configured in locations in an arrow-shaped manner or with a tip or in a conical manner or possibly as a barb, with the result that the mounting of the elastomer component can take place with a moderate expenditure of force, in order to hold the elastomer component securely in its position during operation.
As an alternative or in addition, the elastomer component can be configured with a corresponding geometry for easy mounting and obstructed secure holding.
As an alternative, the elastomer component or components can be attached fixedly to the machine, and the counterpart or counterparts can be fixed/arranged on the covering unit or heard.
The geometry of the counterpart can in practice be adapted in any desired way.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

One exemplary embodiment of the invention is shown in the drawing and will be explained in greater detail in the following text on the basis of the drawing figures, in which, in detail:

FIGS. 1A and 1B show a diagrammatic, partially sectioned detail of a first closure variant in accordance with the invention in a closure position and in a partially open position,

FIG. 2 shows a diagrammatic cross section through the second closure variant in accordance with the invention, and

FIGS. 3AA-3BD show a diagrammatic cross section of the third closure variant in accordance with the invention in various positions of closing and of opening.

### DETAILED DESCRIPTION

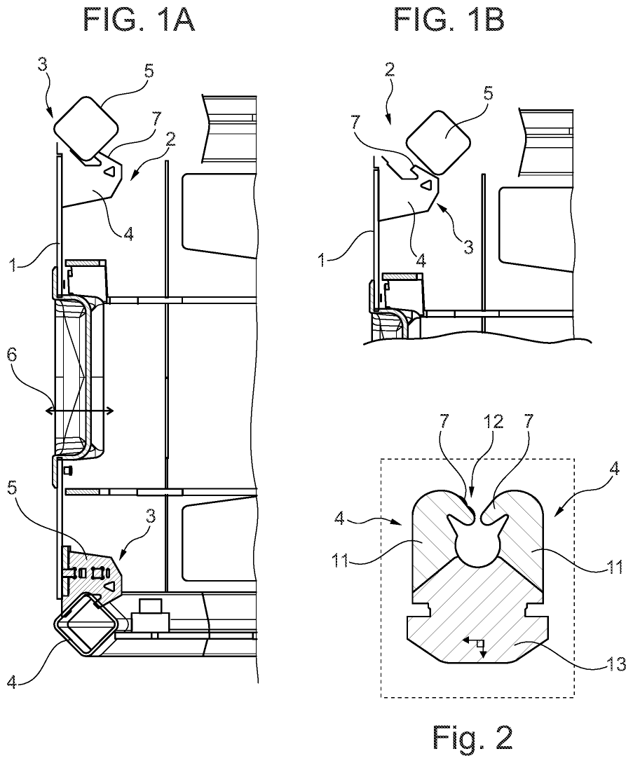

In FIGS. 1A and 1B, a detail of a covering unit 1 or motor hood 1 can be seen diagrammatically in a closure position (cf. FIG. 1A)) and in a partially open position (cf. FIG. 1B)). Here, the motor hood 1 closes an engine opening 2 during operation, and makes opening and possibly maintenance of the drive engine which is not shown in greater detail or the like possible.

A closure 3 comprises firstly a so-called second closure element 5 which is arranged fixedly on the loadbearing frame of a mobile work machine such as a vibrator or the like, or a square tube 5 which can be brought into an operative connection with a rubber element 4 or elastic element 4 or so-called first closure element 4 in accordance with the invention. This rubber element 4 has a lug 7 or a projection 7 or a barb 7, whereby the motor hood 1 is secured effectively in the closure position according to FIG. 1A against unintended or spontaneous opening. This means that the motor hood 4 is fixed or held in the direction of an adjustment path 6 here.

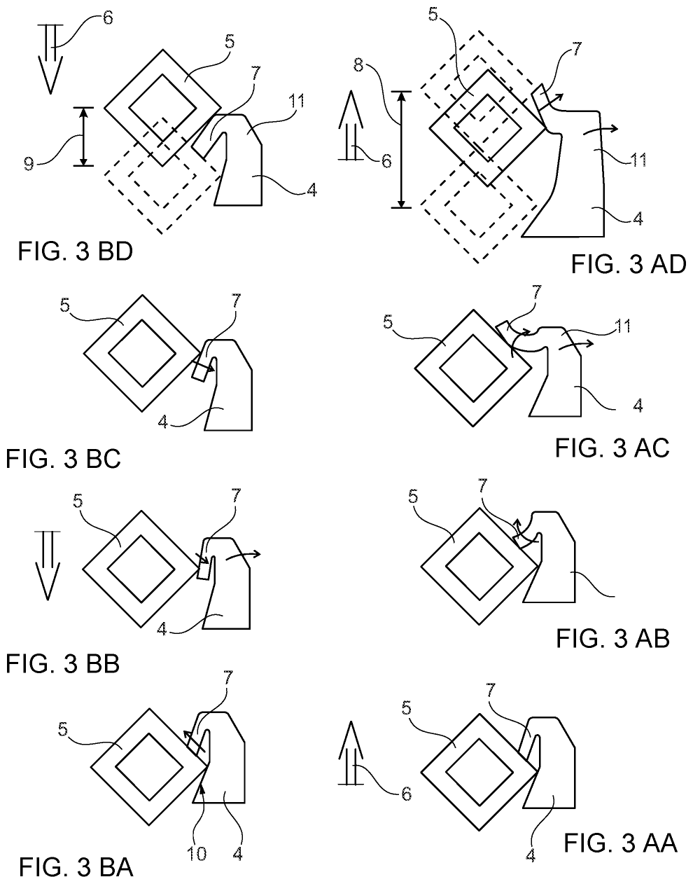

FIG. 1B shows a partially open position of the engine hood 4, the rubber element 4 touching or being in contact with the tube 5. This position also corresponds in principle to FIG. 3BB. The closure position according to FIG. 1A also corresponds in principle to the closure positions which are shown in FIG. 3AA and FIG. 3BA.

In FIGS. 3AA-3BD, various positions or shapes of the closure 3 or the two closure elements 4, 5 are namely depicted diagrammatically in order to illustrate the invention. For instance, FIGS. 3AA-3AD show various positions during opening or the opening operation, and FIGS. 3BA-3BD show various positions during closing or the closing operation.

FIG. 3AD shows the two “maximum” positions of the tube 5 or second closure element 5 in relation to the first closure element 4 or rubber element 4, in part using dashed lines. It can thus be seen that a release path 8 is considerably longer or greater than a fixing path 9. Here, the release path 8 and the fixing path 9 extend firstly from the closure position (see shown in each case using dashed lines in FIGS. 3AD and 3BD and see FIGS. 3AA and 3BA in each case as far as a position, in which firstly the two closure elements 4, 5 touch or are in contact for the first time in the direction of the adjustment path during closing (cf. FIG. 3BD) or in which secondly the two closure elements 4, 5 last touch or are in contact (cf. FIG. 3AD).

For improved understanding of the movement sequences during opening and closing, arrows are additionally depicted which diagrammatically show the deformation or bends of the rubber element 4 or its lug 7. It can thus be seen that the lug 7 has a smaller cross section than in flank portion 11 of the rubber element 4, with the result that this portion 11 is deformed to a lesser extent both during opening and during closing/fixing than the lug 7. Precisely during opening, however, this portion 11 advantageously generates a restoring force or resistance which is to be overcome. Just like the paths of differing length, that is to say the release path 8 and the fixing path 9, this has a positive effect on the closure 3 in the context of the invention.

Considerably more energy thus has to be applied during opening according to FIG. 3AA-FIG. 3AD—than during closing according to FIG. 3BA—FIG. 3BD, which effectively prevents unintended opening during operation of the vibrator or the like and is therefore of great advantage. The opening force which is to be applied by the user can advantageously be set or limited, however, by way of the dimensioning of the rubber element 4 or the lug 7 and/or the portion 11. Thus, for example, a maximum opening force to be applied of approximately 200 N can be realized, which is pleasant for normal users.

The rubber element 4 is advantageously shaped in such a way that, during closing in the closure position according to FIG. 3BA, the lug 7 snaps out after bending in according to FIG. 3BB and, in addition, makes contact with the tube 5 at a second location 10, an advantageous prestress of the closure 3 being realized by way of the location 10. The prestressing force can thus be set by way of advantageous dimensioning of the lug 7 and the location 10.

FIG. 2 diagrammatically shows a structural unit 12, in which a so-called second closure element 5 (not shown in greater detail but as far as possible with a round cross section here) can be introduced centrally. The two lugs 7 and the two portions 11 of the structural unit 12 correspond to those of the variants according to FIGS. 1A or 1B or any of FIGS. 3AA-3BD, and are correspondingly deformed in principle during opening or closing/fixing. In addition, these portions 11 are fixed firmly on a base or metal element 13, with the result that the structural unit 12 which can be handled in one piece is realized in an advantageous way.

This structural unit 12 realizes double-sided or symmetrical force loading of the covering unit 1 (not shown in greater detail in FIG. 2). According to FIGS. 1A and 1B, the two closures 3 or closure elements 4 which are individual or spaced apart from one another and are arranged on both sides on an edge portion of the motor hood 1 advantageously make symmetrical or centering force loading possible.

1. A mobile work machine comprising:
a loadbearing frame;
a drive unit for driving a driven device including at least one drive element and/or at least one work element;
at least one covering unit which can be moved about a pivot axis from a closure position that covers an opening in the loadbearing frame to cover the drive unit to an open position exposing the opening to render the drive unit accessible through the opening;
at least one closure unit that is configured to hold the covering unit in the closure position, the closure unit having at least one first closure element and one second closure element which can be adjusted along an adjustment path relative to the first closure element, the closure unit having at least one obstacle that must be overcome during the relative adjustment of the first and second closure elements, with the result that, during an opening movement of the covering unit, the obstacle defines a release path which is oriented in the direction of the adjustment path and that, during a closing movement of the closure unit, defines a fixing path which is oriented in the direction of the adjustment path, wherein the release path is greater than the fixing path.

2. The work machine as claimed in claim 1, wherein the fixing path extends from an initial contact position to the closure position, the initial contact position being configured as a first contact position in the direction of the adjustment path, and wherein the release path for the opening extends from the closure position to an end contact position, the end contact position being configured as a last release contact position in the direction of the adjustment path during the opening movement of the closure unit.

3. The work machine as claimed in claim 1, wherein the first closure element comprises at least the obstacle, and wherein the obstacle is configured as a projecting portion of the first closure element.

4. The work machine as claimed in claim 1, wherein at least one of the obstacle and the projecting portion is oriented at least partially in the direction of the fixing path, and wherein an acute angle is provided between the fixing path and a longitudinal axis of at least one of the obstacle and the projecting portion.

5. The work machine as claimed in claim 1, wherein the first closure element is configured as an elastically deformable elastomer element.

6. The work machine as claimed in claim 1, wherein the first closure element has at least one elastically deformable barb.

7. The work machine as claimed in claim 3, wherein a first cross section of at least one of the obstacle and the projecting portion is of smaller configuration than the second cross section of a second portion of the first closure element.

8. The work machine as claimed in claim 1, wherein the second closure element has a square cross section.

9. The work machine as claimed in claim 1, wherein at least two first closure elements are arranged on the covering unit.

10. The work machine as claimed in claim 1, wherein the second closure element is arranged between two first closure elements.

11. The work machine as claimed in claim 1, further comprising a single-piece closure element structural unit comprising at least two first closure elements.

12. The work machine as claimed in claim 1, wherein at least one prestressing unit is provided for at least one of prestressing the closure unit and for generating a prestressing force which acts on the first closure element or the covering unit.

13. The work machine as claimed in claim 1, wherein at least one of the first closure element and the second closure element is arranged on an edge portion of the covering unit.

14. The work machine as claimed in claim 1, wherein at least one of the first closure element and the second closure element is arranged on an edge portion of the covering unit, which edge portion lies opposite the pivot axis.

15. The work machine as claimed in claim 1, wherein the covering unit is configured as a motor hood or as a cabin door.

16. The work machine as claimed in claim 1, wherein the work machine comprises one of a wheel loader, a telescopic handler, an excavator, a tractor, and a soil compaction apparatus formed from one of a vibratory rammer and a vibratory plate.

17. The work machine as claimed in claim 1, wherein the driven device comprises 1) a drive element comprising a least one of a drive wheel/roller, a crawler track unit, and a vibratory element, and/or 2) a work element comprising at least one of a gripping arm, a scoop, a fork, a vibratory element.
